(19) United States
(12) Patent Application Publication
(10) Pub. No.: US 2025/0203746 A1
(43) Pub. Date: Jun. 19, 2025

(54) BEAM DIAPHRAGM, EUV LIGHT SOURCE, AND METHOD FOR OPERATING AN EUV LIGHT SOURCE

(71) Applicant: TRUMPF Lasersystems for Semiconductor Manufacturing GmbH, Ditzingen (DE)

(72) Inventor: Stefan Piehler, Stuttgart (DE)

(21) Appl. No.: 19/073,074

(22) Filed: Mar. 7, 2025

Related U.S. Application Data
(63) Continuation of application No. PCT/EP2023/074278, filed on Sep. 5, 2023.

(30) Foreign Application Priority Data
Sep. 9, 2022 (DE) 10 2022 122 963.7

(51) Int. Cl. H05G 2/00

(52) U.S. Cl. CPC H05G 2/0086; H05G 2/0084

(57) ABSTRACT

A beam diaphragm includes a diaphragm opening for allowing passage of a first portion of laser beam, a deflector for deflecting a second portion of the laser beam not allowed to pass through the diaphragm opening, a reflector for reflecting the second portion of the laser beam deflected by the deflector, and a sensor for detecting a reflex of the second portion of the laser beam.

### CROSS REFERENCE TO RELATED APPLICATIONS

This application is a continuation of International Application No. PCT/EP2023/074278 (WO 2024/052321 A1), filed on Sep. 5, 2023, and claims benefit to German Patent Application No. DE 10 2022 122 963.7, filed on Sep. 9, 2022. The aforementioned applications are hereby incorporated by reference herein.

### FIELD

Embodiments of the present invention relate to a beam diaphragm. Embodiments of the invention also relate to an EUV light source having such a beam diaphragm, and to a method for operating an EUV light source.

### BACKGROUND

Beam diaphragms having an opening for allowing the passage of a laser beam and a sensor unit are known. Such beam diaphragms are used in EUV light sources to detect misalignments of the laser beam.

Such a device for monitoring the alignment of a laser beam is described, for example, in WO2015172816A of the applicant. This comprises a detector having an opening for allowing the passage of the laser beam, at least two temperature sensors attached to the detector, and a temperature monitoring device connected to the at least two temperature sensors in order to monitor the alignment of the laser beam relative to the opening. The at least two temperature sensors have either a temperature-dependent resistance that increases with increasing temperature or a temperature-dependent resistance that decreases with increasing temperature, and the at least two temperature sensors are connected to the temperature monitoring device in a series circuit. An EUV radiation generating device which has at least one device as described above for monitoring the alignment of a laser beam is also disclosed.

It has been shown that when using high laser powers and short pulse durations, such a detector may react too slowly, resulting in damage to the diaphragm.

### SUMMARY

Embodiments of the present invention provide a beam diaphragm. That beam diaphragm includes a diaphragm opening for allowing passage of a first portion of laser beam, a deflector for deflecting a second portion of the laser beam not allowed to pass through the diaphragm opening, a reflector for reflecting the second portion of the laser beam deflected by the deflector, and a sensor for detecting a reflex of the second portion of the laser beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of the beam diaphragm;

FIG. 2 shows an illustration of the geometric conditions of the beam diaphragm according to some embodiments;

FIG. 3a, FIG. 3b, FIG. 3c and FIG. 3d show the beam diaphragm with different beam positions, beam sizes and beam shapes of the laser beam, according to some embodiments;

FIG. 4 shows a further embodiment of the beam diaphragm; and

FIG. 5 shows an EUV light source having the beam diaphragm according to some embodiments.

### DETAILED DESCRIPTION

Embodiments of the invention provide a beam diaphragm, an EUV light source having such a beam diaphragm, and a method for operating such an EUV light source, with which the aforementioned disadvantages are reduced, preferably avoided. According to some embodiments, a misalignment of a laser beam can be detected.

The beam diaphragm according to embodiments of the invention has a diaphragm opening for allowing the passage of a laser beam, a deflection unit for deflecting portions of the laser beam not guided through the diaphragm opening, a reflection unit for reflecting the deflected portions of the laser beam, and a sensor unit for detecting the reflex of the deflected portions of the laser beam.

If the laser beam is correctly aligned, i.e., in the target beam position, this will be allowed to pass completely through the diaphragm opening of the beam diaphragm. If the laser beam is misaligned, the portions of the laser beam that are not allowed to pass through the diaphragm opening are incident on the deflection unit and are thereby deflected onto the reflection unit. The portions of the laser beam incident on the beam diaphragm are therefore not absorbed but deflected, so that, in the event of a misalignment of the laser beam, the beam diaphragm does not heat up. The deflected portions of the laser beam are then reflected as a reflex at the reflection unit so that they are incident on the sensor unit. This detects the reflex of the deflected portions of the laser beam. The alignment of the laser beam is thus monitored independently of the temperature of the beam diaphragm. A misalignment of the laser beam is detected immediately and not only when the beam diaphragm has reached a certain temperature, thus avoiding a time delay between the misalignment and the detection of the misalignment of the laser beam. As the beam diaphragm does not heat up in the event of misalignment of the laser beam, damage due to an excessively high surface temperature of the beam diaphragm, e.g., local melting of the material of the beam diaphragm, can be avoided. Such local melting of the beam diaphragm material often produces smoke and metal vapor, which can damage optical elements downstream in the beam path. If the misalignment of the laser beam is not discovered in good time, people nearby, such as operators, may also be harmed.

According to a further embodiment of the invention, the deflection unit has a deflection surface which is aligned transversely with respect to a target beam position of the laser beam. The deflection surface is aligned in such a way that those portions of the misaligned laser beam that are not allowed to pass through the diaphragm opening are deflected to the reflection unit. In this way, the portions of the laser beam incident on the beam diaphragm are advantageously deflected away from the deflection unit so that it does not heat up.

In the target beam position, the laser beam hits optical elements arranged along its beam path at a predetermined angle and at a predetermined position. If the laser beam is misaligned, i.e., its beam position deviates from the target beam position, it may not hit the optical elements in its beam path, or may not hit them at the predetermined position or at the predetermined angle-particularly in the case of long beam paths of several meters. A beam axis of the misaligned laser beam runs parallel or tilted to a beam axis of the laser beam that is allowed to pass through the beam diaphragm in the target beam position. In the target beam position, the laser beam is aligned so that no portions of the laser beam are incident on the beam diaphragm.

According to a further embodiment of the invention, the deflection surface encloses an angle of 30° to 60° with the target beam position. If the beam axis of the misaligned laser beam runs parallel to the beam axis of the laser beam in the target beam position, the portions of the laser beam that are not allowed to pass through the diaphragm opening are deflected accordingly by an angle of between 120° and 60°. If the beam axis of the misaligned laser beam is tilted with respect to the beam axis of the laser beam in the target beam position, the portions of the laser beam that are not allowed to pass through the diaphragm opening may be deflected by an even larger angle, depending on the alignment of the beam axis of the misaligned laser beam.

An angle of 45° between the deflection surface and the target beam position has proven to be particularly advantageous. At this angle—in the case that the beam axis of the laser beam in the target beam position and the beam axis of the misaligned laser beam are parallel—the portions of the laser beam that are not allowed to pass through the diaphragm opening are deflected by an angle of 90°. Since the deflection surface is arranged in relation to the reflection unit in such a way that the deflected portions of the laser beam are incident on the reflection unit, such an arrangement enables the reflection unit to be arranged on the beam diaphragm in a structurally simple manner.

According to a further embodiment of the invention, the deflection unit delimits the diaphragm opening at least in sections. An arrangement in which the deflection unit delimits the diaphragm opening in a ring-shaped manner at least in sections has proven to be particularly advantageous. In the case that the deflection unit completely surrounds the diaphragm opening in a ring-shaped manner, the portions of the laser beam deflected by the deflection unit then form a virtual intersection point in the center of the diaphragm opening. If the deflection unit only delimits the diaphragm opening in a ring-shaped manner in sections, then the deflected portions of the laser beam form a virtual intersection point in the center of a notional circle, wherein the ring section extends along a circumference of this circle. In this case, the deflected portions of the laser beam form a virtual intersection point at a notional center of the diaphragm opening.

According to a further embodiment of the invention, the deflection unit is preferably designed as a conical annular mirror, or as an internally reflecting annular prism, or as a section of a conical annular mirror or an internally reflecting annular prism. The cutout of the conical annular prism or the internally reflecting annular prism can in particular be designed as a ring section, so that the conical annular mirror or the internally reflecting annular prism does not completely delimit the diaphragm opening. Designing the deflection unit as a conical annular prism or reflective annular prism enables a particularly simple structural design of the beam diaphragm.

The conical annular mirror or the reflecting annular prism or their cutouts in particular have an edge that is as sharp as possible. This ensures that the laser beam incident on the edge of the conical annular mirror or the reflecting annular prism is not, or almost not, deflected in directions that do not point towards the reflection unit.

To prevent the laser beam from being deflected by an inner surface of the conical annular mirror or the reflecting annular prism in directions that do not point towards the reflection unit, this inner surface may also be undercut. An undercut of up to 5° between the inner surface of the conical annular mirror or the reflecting annular prism and the target beam position has proven to be particularly effective.

The deflection unit can be made of optical glass, e.g., quartz glass, N-BK7, Zerodur, or crystals (ZnSe, sapphire).

According to a further embodiment of the invention, the reflection unit has a reflection surface on which the deflected portions of the laser beam are reflected. The reflection surface is arranged so that the reflex of the deflected portions of the laser beam is concentrated in a sensor point, which is preferably arranged between the deflection unit and the reflection surface. In a particularly advantageous embodiment of the invention, a sensor for detecting the radiation concentrated in the sensor point is arranged in the sensor point. By concentrating the deflected portions of the laser beam on the sensor unit, only a small mass is heated up compared to beam diaphragms that absorb incident laser radiation. The beam diaphragm therefore reacts much faster and more sensitively to a misalignment of the laser beam than an absorbing beam diaphragm. This allows switching times to be minimized and the safety of the overall installation to be increased.

According to a further embodiment of the invention, the reflection surface is at least partially elliptical in shape. The reflection surface, which is designed to be at least partially elliptical, is assigned a first focal point and a second focal point, wherein the first focal point is located on the sensor point. The second focal point is located on a beam axis of the laser beam that is allowed to pass through the diaphragm opening in the target beam position. In the case of a deflection unit that is ring-shaped or partially ring-shaped, the second focal point is also located in the center or notional center of the diaphragm opening. The reflection surfaces, which are at least partially elliptical, reflect and focus the reflex of the deflected portions of the laser beam onto the sensor point. This takes advantage of a fundamental property of an elliptical mirror, according to which all beams that have or appear to have their origin in the first focal point of the ellipse are imaged at the second focal point. The ellipse underlying the reflection surface is designed in such a way that the first focal point is located in the virtual intersection point of the deflected portions of the laser beam in the center, or notional center, of the diaphragm opening. The second focal point is located on the sensor point, so that all deflected portions of the laser beam are focused on the sensor point. The advantage of such a design of the beam diaphragm is that all deflected portions of the laser beam can be detected.

The reflection surface can be made of copper, particularly by milling. A laser beam on a copper surface is reflected with a wavelength of e.g., 10.6 μm, so that a beam diaphragm with a reflection surface made of copper is particularly advantageous as a beam diaphragm for allowing the passage of a CO2 laser beam. Due to the elliptical shape of the reflection surface at least in sections, optical imaging properties play a subordinate role as long as the concentrating functionality is guaranteed. In order to produce the reflection surface, processes can therefore be used that typically produce surfaces with only minimal surface roughness, such as finish milling, polishing, laser cutting or wire EDM.

The reflection surfaces can be provided with a reflective coating, e.g., a gold or aluminum layer.

According to a further embodiment of the invention, a cover unit is arranged on the beam diaphragm so that the sensor unit is shielded from direct contact with portions of the laser beam. The cover unit is arranged in front of the sensor unit as seen in the beam propagation direction of the laser beam. Only those portions of the laser beam which are incident on the deflection unit and are thereby deflected to the reflection surfaces are incident on the sensor unit.

According to a further embodiment of the invention, the cover unit has a, in particular circular, recess for allowing the passage of the laser beam through the diaphragm opening. The deflection unit and the cover unit are arranged concentrically to one another so that the deflection unit is not covered by the cover unit when viewed in the beam propagation direction of the laser beam. The cover unit has a chamfer, in particular on an inner surface facing the recess, in order to prevent the laser beam from being deflected in directions that do not point towards the reflection unit. The provision of a circular recess in the cover unit and a concentric arrangement of deflection unit and cover unit enables a particularly structurally simple design of the beam diaphragm.

According to a further embodiment of the invention, the sensor unit is designed as a temperature sensor, in particular as a pyrometer or resistance temperature sensor. The sensor unit can be glued or screwed into absorbent-coated copper sleeves. The sensor unit can also be designed as an optical sensor, in particular as a photodiode, photovoltaic diode or camera. The provision of commercially available sensors as sensor units enables a particularly cost-effective and simple design of the beam diaphragm.

According to a further embodiment of the invention, the beam diaphragm has at least two, preferably six, reflection units, each of which has the same first focal point, which is located on the beam axis of the laser beam allowed to pass through the diaphragm opening in the target beam position. The reflection units are arranged around the diaphragm opening. By providing several reflection units arranged around the diaphragm opening, it is not only possible to determine that the laser beam is misaligned, but also to detect the position of the misaligned laser beam in relation to the target beam position, as well as the shape and/or size of the laser beam allowed to pass through the diaphragm opening.

If the deflection unit delimits the diaphragm opening completely in a ring-shaped manner, for example in the form of a reflective annular prism or a conical annular mirror, the portions of the laser beam that are not allowed to pass through the diaphragm opening are deflected by the deflection unit to one of the reflection units, regardless of their position in relation to the diaphragm opening. Thus, deviations of the beam position of the laser beam from the target beam position can be detected independently of the position of the misaligned laser beam.

According to a further embodiment of the invention, each reflection unit is assigned a sensor unit. The sensor unit is connected to at least one readout unit. In addition to the pure safety functionality, the individual evaluation of the respective sensor units also enables an analysis of the beam position, beam size and/or beam shape, e.g., the ellipticity of the laser beam that is allowed to pass through the diaphragm opening.

The sensor units can also be evaluated integrally. For example, the sensor units can be designed as temperature sensors that are connected to a common water circuit. A change in the water temperature in the water circuit is then detected, indicating a misalignment of the laser beam.

Alternatively, instead of the individual sensor units, water-cooled webs can be provided which are hydraulically connected in series. An increase in temperature of the water passing through the water-cooled webs is proportional to the laser power absorbed by the water-cooled webs at a given flow rate.

According to an embodiment of the invention, the reflection surfaces, which are elliptical at least in sections, each have a vertex. The vertices are each arranged around a notional circular line, in particular rotationally symmetrically, around the beam axis of the laser beam allowed to pass through the diaphragm opening in the target beam position. This arrangement enables a simple, compact and cost-effective mechanical construction of the beam diaphragm while simultaneously designing it with only reflective optical elements, except for the sensor.

If the beam diaphragm has several reflection units, the reflection surfaces assigned to the reflection units can be made, in particular milled, from a single component, for example from copper. A concentrator produced in this way, which has a plurality of reflection surfaces that are at least partially elliptical, can be formed in one piece.

The concentrator can also be composed of several reflection units. If the deflection unit is designed as an internally reflecting annular prism and the concentrator is composed of several reflection units, this has the advantage that the respective sensor units and the diaphragm opening can be mechanically separated from one another so that the beam path of the laser can be sealed from the sensor unit. If the sensor unit is destroyed by a misalignment of the laser beam, contamination of the beam path is thus prevented.

Embodiments of the invention also relate to an EUV light source having a beam diaphragm as described above, a seed laser for generating a laser beam, a driver laser device for amplifying the laser beam, a vacuum chamber into which a target material can be introduced into a focusing region, a focusing unit for focusing the laser beam in the focusing region for generating EUV radiation, and a beam guiding device for guiding the laser beam to the focusing unit. In such an EUV light source, the beam diaphragm can be used to monitor the alignment of the laser beam. This can prevent damage to the beam diaphragm and/or other components arranged in the beam path of the laser beam.

It is understood that the beam diaphragm described above can be advantageously used not only in an EUV light source, but also in a laser processing machine or the like, especially when a high-power pulsed laser beam is used.

Embodiments of the invention also relate to a method for operating such an EUV light source comprising the following steps:
generating the laser beam in the seed laser,
amplifying the laser beam in the driver laser device,
allowing the passage of the laser beam through the beam diaphragm,
in the event that the sensor unit detects radiation with an intensity, power or energy which is above a threshold value:
switching off the seed laser and/or the driver laser device and/or interrupting the laser beam by a beam interruption unit,
in the event that the sensor unit detects radiation with an intensity, power or energy which is below the threshold value, or detects no radiation:
focusing the laser beam in the focusing unit onto the focusing region for generating EUV radiation.

In order to avoid damage to the beam diaphragm and/or another component arranged in the beam path of the laser beam, it is advantageous to switch off the laser beam if the sensor unit detects radiation with an intensity, power or energy above the threshold value. The laser beam can be interrupted by a beam interruption unit, e.g., a shutter, so that components downstream of the beam diaphragm in the beam path are not damaged in the event of misalignment of the laser beam. Alternatively or in addition, the seed laser or the driver laser device can also be switched off if the sensor unit detects radiation with an intensity, power or energy above the threshold value in order to prevent damage further along in the beam path of the laser beam. If the sensor unit detects radiation with an intensity, power or energy below the threshold value or detects no radiation, the laser beam in the focusing unit is focused on the focusing region. In the focusing region, the laser beam is focused on a target material, e.g., a tin droplet. The target material then emits EUV radiation as a result of irradiation with the laser beam.

The features mentioned above and those yet to be presented may be used in each case alone or jointly in any desired combinations. The embodiments shown and described should not be understood as an exhaustive list, but are of an exemplary character.

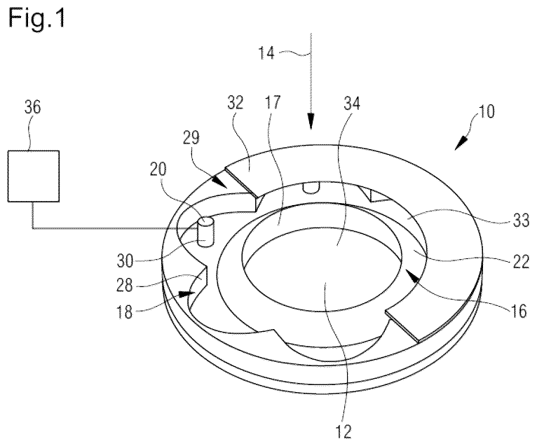

FIG. 1 shows a beam diaphragm 10 having a diaphragm opening 12, a deflection unit 16, six reflection units 18, six sensor units 20 and a cover unit 32 having a circular recess 34. The beam diaphragm 10 may have any number of reflection units 18 grouped around the diaphragm opening 12. The deflection unit 16 is designed as a conical annular mirror in FIG. 1. The deflection unit 16 can also be designed as another reflective optical element, for example as an internally reflecting annular prism. The conical annular mirror has a deflection surface 22. It can be provided with an undercut of up to 5° on its inner side 17, which is not shown in FIG. 1. The reflection units 18 each comprise a partially elliptical reflection surface 28, wherein each of the reflection surfaces 28 is assigned a sensor unit 20.

The deflection unit 16 is mounted on a cover plate 33 on which the sensor units 20 and reflection units 18 are mounted. The circular recess 34 of the cover unit 32 is arranged concentrically to the diaphragm opening 12 so that the sensor units 20 and the reflection surfaces 28 are covered by the cover unit 32. Only the deflection unit 16 is visible to a laser beam 14 which, as shown in FIG. 1, is allowed to pass through the beam diaphragm 10 from a side facing the cover unit 32. The sensor units 20 are each arranged in a sensor point 30 which is located between the respective reflection surface 28 and the deflection unit 16.

The sensor units 20 are designed, for example, as thermocouples, e.g., absorbent-coated copper sleeves, which are glued or screwed onto the cover plate 33.

The sensor units 20 are each connected to a readout unit 36 in terms of signaling. The readout unit 36 is designed to evaluate a signal transmitted by the respective sensor units 20 in order to determine at which of the sensor units 20 radiation was detected.

A plurality of readout units 36 can also be provided. Each sensor unit 20 is then connected to a respective readout unit 36. These then pass the received signals on to a central control unit.

In an alternative embodiment, the sensor units 20 can also be connected in series. One of the sensor units 20 connected in series is then in turn connected to a readout unit 36. In this case, the readout unit 36 or a control unit connected to the readout unit 36 evaluates the signal of the sensor units 20 integrally. The beam position of the laser beam 14 in relation to the target beam position, the beam shape and the beam size cannot be determined in this case. However, it can be determined whether the beam position of the laser beam 14 deviates from the target beam position. If this is the case, the laser beam 14 can be switched off depending on whether the energy, intensity or power of the laser beam 14 measured at the sensor units 20 is above a threshold value.

The reflection surfaces 28 are formed on a concentrator 29, which is formed as a milled part, for example from copper. The reflection surfaces 28, which are elliptical in sections, are processed in such a way that they have a high degree of reflectivity. Sufficient surface roughness can be achieved by processes such as finish milling, polishing, wire EDM or laser cutting, since these surfaces do not have to be perfect mirror surfaces due to their ellipticity.

The laser beam 14 is ideally aligned in a target beam position. In this beam position, the laser beam 14 is allowed to pass through the diaphragm opening 12 of the beam diaphragm 10 without any portions of the laser beam 14 being incident on the beam diaphragm 10. The beam axis of the laser beam 14 in the target beam position runs at an angle of 90° to a plane in which the cover unit 32 and/or the cover plate 33 is arranged.

If the laser beam 14 is misaligned, its beam axis is offset from the beam axis in the target beam position and/or runs at an angle to the beam axis of the laser beam 14 in the target beam position. In this case, portions of the laser beam 14 may be incident on the deflection unit 16 and be deflected thereby onto one or more of the reflection units 18.

Even if the diameter of a cross section of the laser beam 14 is larger than the diameter of the diaphragm opening 12 or the laser beam 14 has an elliptical shape, it is possible that portions of the laser beam 14 are incident on the deflection surface 16 and are deflected thereby onto one or more reflection units 18. The reflection surfaces 28 of the reflection units 18 reflect the reflex 21 of the deflected portions of the laser beam 14 onto the respective sensor units 20. Finally, the sensor units 20 detect an energy, power or intensity of the reflex 21 and transmit the detected measured values to one or more readout units 36.

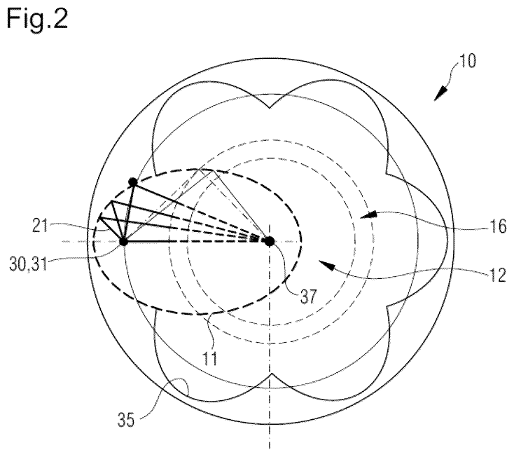

The geometrical conditions of the beam diaphragm 10 are illustrated in FIG. 2. The reflection surfaces 28 each extend along a partial section of a circumferential line of a notional ellipse 11. A first focal point 31 of the respective ellipse 11 is located between the reflection surface 28 assigned to the ellipse 11 and the deflection unit 16, while a second focal point 37 is located in the center of the ring-shaped diaphragm opening 12. Those portions of the laser beam 14 which are not allowed to pass through the diaphragm opening 12 are incident on the deflection unit 16 and are deflected thereby as a reflex 21 at an angle of 90° onto the reflection surfaces 28. The reflection surfaces 28 concentrate the reflex 21 on the first focal point 31 of the notional ellipse, which coincides with a sensor point 30 in which the sensor unit 20 is arranged. If the portions of the laser beam 14 deflected by the deflection unit 16 are extended in the opposite direction to their propagation, they form a virtual intersection point which coincides with the second focal point 37 of the notional ellipse 11 and the center of the diaphragm opening 12. This makes use of the fundamental property of an elliptical mirror, according to which radiation that comes, or appears to come, from one of the focal points is always reflected onto the other focal point. The notional ellipse 11, along which the reflection surfaces 28 extend, is designed such that the portions of the laser beam 14 which are not allowed to pass through the diaphragm opening 12 and are consequently incident on the deflection unit 16 are concentrated on the sensor point 30 and thus the sensor unit 20.

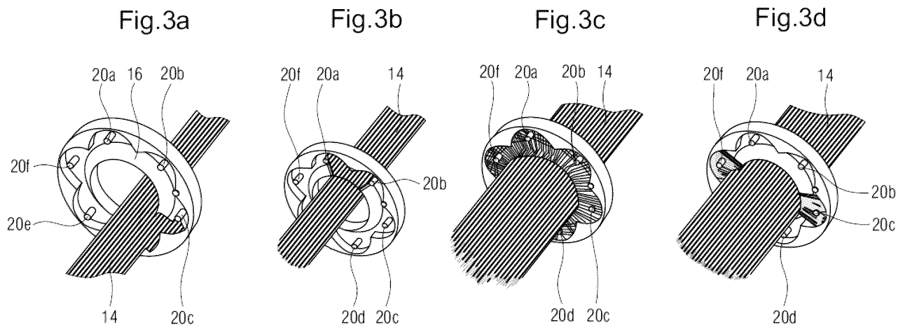

FIGS. 3a, b, c and d show the beam diaphragm 10 in different application situations.

In FIGS. 3a and b, the laser beam is aligned in a decentered manner, having a beam axis that is offset from the target beam position. In this case, only the sensor units 20c, d in FIG. 3a or 20a, b in FIG. 3b respond, to which the portions of the laser beam 14 deflected by the deflection unit 16 are reflected. The respective sensor units 20c, d and 20a, b detect the power, energy or intensity of the incident radiation and forward this to the readout unit 36. In this way, it can be determined which of the sensor units 20 a to f has detected radiation. From this, the position of the beam axis of the misaligned laser beam 14 in relation to the target beam position can be determined.

FIG. 3c shows a laser beam 14 whose cross section is larger than a target beam cross section. If this laser beam 14 is allowed to pass through the diaphragm opening 12, all sensor units 20 a to f respond.

Finally, FIG. 3d shows a laser beam 14 whose cross-section is elliptical. If this laser beam 14 is allowed to pass through the diaphragm opening 12, opposing sensor units, sensor units 20a and d in the case shown in FIG. 3d, respond.

In FIGS. 3a to d, the beam diaphragm 10 is shown without the cover unit 32 for reasons of clarity.

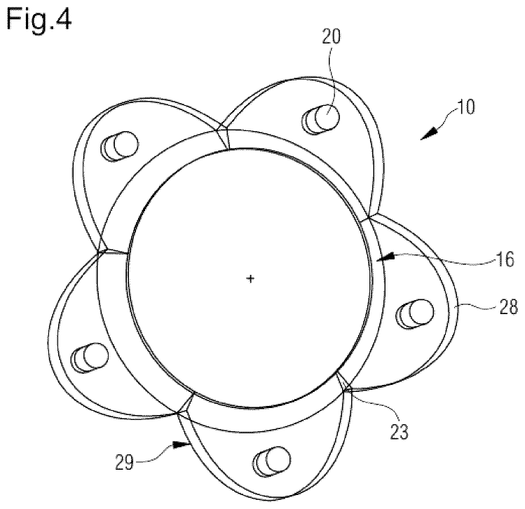

FIG. 4 shows an embodiment of the beam diaphragm 10 in which the concentrator 29 is composed of a plurality of segments. In FIG. 4, the deflection unit 16 is designed as an internally reflecting annular prism. The individual segments of the concentrator 29 are sealed from the diaphragm opening 12 by webs 23, so that in the event that the sensor units 20 are damaged or destroyed, the optical elements arranged in the beam path of the laser beam 14 are not damaged.

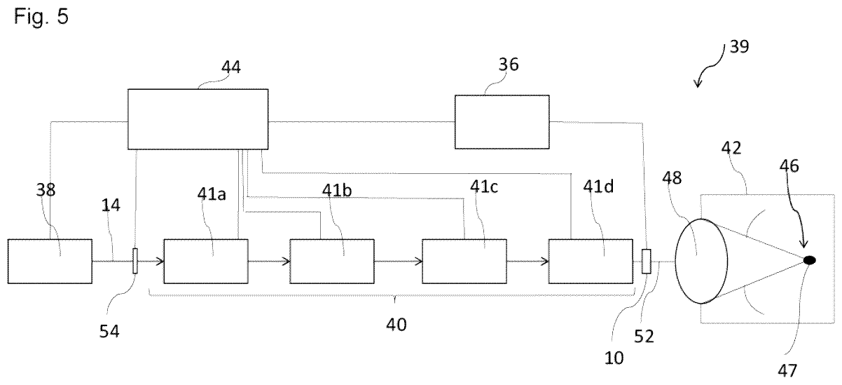

FIG. 5 shows an EUV light source 39 having a seed laser 38, a driver laser device 40, a vacuum chamber 42, a beam guiding device 52 and a focusing unit 48. The laser beam 14 is generated by the seed laser 38 and amplified in the driver laser device 40. The amplified laser beam 14 is guided by the beam guiding device 52 to the focusing unit 48, where it is focused on the focusing region 46. A target material 47 can be introduced into the focusing region 46, which emits radiation, in particular EUV radiation, due to the irradiation with the laser beam 14. In FIG. 5, the beam diaphragm 10 is arranged in the beam guiding device 52. It is understood that the beam diaphragm 10 can also be arranged in another part of the EUV light source, for example between two amplifiers 41a, 41b of the driver laser device 40 or between the seed laser 38 and the driver laser device 40.

If, during operation of the EUV light source 39, one or more of the sensor units 20 detects a measured value that is above a threshold value, the readout unit 36 or a control unit 44 connected to the readout unit 36 sends the seed laser 38, the driver laser device 40 and/or the beam interruption unit 54 the signal to switch off the laser beam 14. For this purpose, the readout unit 36 or the control unit 44 is connected in terms of signaling to the seed laser 38, the driver laser device 40 and/or a beam interruption unit 54. In this manner, the beam path of the laser beam is protected from the consequences of a misalignment of the laser beam 14.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A beam diaphragm comprising:
a diaphragm opening for allowing passage of a first portion of laser beam,
a deflector for deflecting a second portion of the laser beam not allowed to pass through the diaphragm opening,
a reflector for reflecting the second portion of the laser beam deflected by the deflector, and
a sensor for detecting a reflex of the second portion of the laser beam.

2. The beam diaphragm according to claim 1, wherein the deflector has a deflection surface aligned transversely with respect to a target beam position of the laser beam, so that the second portion of the laser beam incident on the deflector is capable of being deflected onto the reflector.

3. The beam diaphragm according to claim 2, wherein the deflection surface encloses an angle of 30° to 60° with a target beam position of the laser beam.

4. The beam diaphragm according to claim 1, wherein the deflector delimits the diaphragm opening at least in sections in an annular manner.

5. The beam diaphragm according to claim 1, wherein the deflector is configured as a conical annular mirror or as an internally reflecting annular prism.

6. The beam diaphragm according to claim 1, wherein the reflector has a reflection surface so that the reflex of the second portion of the laser beam is capable of being concentrated in a sensor point of the reflection surface, wherein the sensor point is arranged between the deflector and the reflection surface associated with the sensor point.

7. The beam diaphragm according to claim 6, wherein the reflection surface is configured to be elliptical at least in sections, wherein a first focal point of the reflection surface is located on the sensor point and a second focal point of the reflection surface is located on a beam axis of the laser beam that is allowed to pass through the diaphragm opening in a target beam position.

8. The beam diaphragm according to claim 1, further comprising a cover arranged in front of the sensor as seen in a beam propagation direction of the laser beam, so that the sensor is shielded from direct contact with portions of the laser beam.

9. The beam diaphragm according to claim 8, wherein the cover has a circular recess for allowing the passage of the first portion of the laser beam, and the deflector and the cover are arranged concentrically to one another, so that the deflector is not covered by the cover when viewed in the beam propagation direction of the laser beam.

10. The beam diaphragm according to claim 1, wherein the sensor is configured as a temperature sensor.

11. The beam diaphragm according to claim 7, wherein the beam diaphragm comprises at least two reflectors, each of which has the same second focal point, which is located on the beam axis of the laser beam allowed to pass through the diaphragm opening in the target beam position.

12. The beam diaphragm according to claim 11, wherein each reflector is assigned a respective sensor, wherein the respective sensor is connected to at least one readout unit.

13. The beam diaphragm according to claim 11, wherein each of the elliptical reflection surfaces has a vertex, wherein the vertices are arranged on a notional circular line around the beam axis of the laser beam allowed to pass through the diaphragm opening in the target beam position.

14. An EUV light source comprising:
a beam diaphragm according to claim 1,
a seed laser for generating the laser beam,
a driver laser device for amplifying the laser beam,
a vacuum chamber into which a target material is to be introduced in a focusing region,
a focusing unit for focusing the laser beam in the focusing region for generating EUV radiation, and
a beam guiding device for guiding the laser beam to the focusing unit.

15. A method for operating an EUV light source according to claim 14, the method comprising:
generating the laser beam in the seed laser,
amplifying the laser beam in the driver laser device,
allowing the passage of the laser beam through the beam diaphragm,
in an event that the sensor detects radiation with an intensity, power or energy above a threshold value, switching off the seed laser and/or the driver laser device, and/or interrupting the laser beam by a beam interruption unit, and
in an event that the sensor detects radiation with an intensity, power or energy below the threshold value, focusing the laser beam in the focusing unit onto the focusing region for generating EUV radiation.
